(19) United States
(12) Patent Application Publication
(10) Pub. No.: US 2024/0113655 A1
(43) Pub. Date: Apr. 4, 2024

(54) PHOTOVOLTAIC DEVICE FOR MOUNTING ON A CONTAINER

(71) Applicant: Hartl Energy GmbH, Mauthausen (AT)

(72) Inventors: Alexander HARTL, Leonding (AT); Dominik HARTL, Allerheiligen im Mühlkreis (AT)

(73) Assignee: Hartl Energy GmbH, Mauthausen (AT)

(21) Appl. No.: 18/374,335

(22) Filed: Sep. 28, 2023

(30) Foreign Application Priority Data
Oct. 3, 2022 (EP) 22020477.0

(51) Int. Cl. H02S 30/20; B65D 88/12; B65D 90/00; F16M 11/20; H02S 30/10

(52) U.S. Cl. CPC H02S 30/20; B65D 88/121; B65D 90/00; F16M 11/2021; H02S 30/10

(57) ABSTRACT

A photovoltaic device for mounting on a container, includes at least two foldable carrier modules, which each have two support elements pivotable relative to one another about at least one pivot axis, a photovoltaic module being fastened to each support element, wherein the at least two foldable carrier modules are arranged adjacent to one another and with their pivot axes aligned with one another, and the support elements of adjacent carrier modules are connected to one another by means of first connecting supports, wherein the first connecting supports extend parallel to the at least one pivot axis and are fastened to the support elements at the end regions thereof remote from the pivot axis, and wherein second connecting supports are fastened to the support elements of the outermost of the at least two carrier modules, which second connecting supports are designed for coupling to a corner fitting of the container.

### CROSS-REFERENCE TO RELATED APPLICATIONS

The present application claims the priority benefit of European Patent Application No. 22020477.0, filed Oct. 3, 2022, entitled “PHOTOVOLTAIC DEVICE FOR MOUNTING ON A CONTAINER”, which is incorporated by reference in its entirety.

### BACKGROUND OF THE INVENTION

### 1. Field of the Invention

The invention relates to a photovoltaic device for mounting on a container.

The invention further relates to a set for assembling such a photovoltaic device as well as to a container on the roof of which a photovoltaic device is mounted.

### 2. Description of the Related Art

For the power supply of temporary dwellings, e.g. on construction sites, mostly mobile or stationary power generating sets, especially diesel generators, are used. Such power generating sets allow autonomous or off-grid operation of various power consumers in or around temporary dwellings. The disadvantage, however, is that fossil-fuel-powered generating sets are considered environmentally harmful.

For self-sufficient electrical energy supply, supply facilities have already become known which have at least one energy converter operated with regenerative energy. Photovoltaic modules are often used for this purpose. It is known to place photovoltaic modules on roofs of various structures, such as residential buildings, industrial buildings and the like.

Containers, which are easy to transport, can be assembled in modules and have standardized dimensions, are often used as temporary dwellings. In particular, so-called ISO containers are used, which originally became widespread for transporting goods. However, ISO containers are often used as construction site containers or office containers.

From US 2017/0222598 A1, a container for use as a dwelling has become known, the roof of which is equipped with solar panels.

The arrangement of photovoltaic modules on containers has also become known in connection with power supply stations, where the container is used for the protected storage of electrical components required for the operation of the power supply station, so that the interior of the container can no longer be used as a dwelling or as a recreation room.

In previous proposals for the arrangement of photovoltaic modules on containers, the modules are usually firmly attached to a container wall or the container roof, or form the roof. It is not envisaged that the photovoltaic modules can be removed again if required. For containers used for mobile and/or temporary housing, such as construction site containers or office containers, there is a requirement to equip the containers with photovoltaic modules only when needed. This increases flexibility in the use of containers, which are suitable for a wide range of applications, only some of which are suitable for equipping with photovoltaic modules.

### SUMMARY OF THE INVENTION

Therefore, the present invention aims to provide a system to equip container roofs with photovoltaic modules in a simple and flexible way only when needed. In particular, the invention aims to provide a photovoltaic system that can be mounted on container roofs in a standardized manner and at the same time transported in a space-saving manner.

For solving this problem, the invention according to a first aspect provides a photovoltaic device for mounting on a container, comprising at least two foldable carrier modules, each having two support elements pivotable relative to each other about at least one pivot axis, wherein a photovoltaic module is attached to each support element, wherein the at least two foldable carrier modules are arranged adjacent to each other and with pivot axes aligned with each other, and wherein the support elements of adjacent carrier modules are connected to each other by means of first connecting supports, wherein the first connecting supports extend parallel to the at least one pivot axis and are fastened to the support elements at the end regions thereof remote from the pivot axis, and wherein second connecting supports are fastened to the support elements of the outermost of the at least two carrier modules, which second connecting supports are designed for coupling to a corner fitting of the container.

The invention is thus based on the idea of assembling a photovoltaic device from a plurality of foldable carrier modules. In this case, the individual carrier modules extend substantially across the width of the container, and two, three or more carrier modules may be arranged side by side, depending on the length of the container, to cover substantially the entire length of the container roof. The at least one pivot axis about which the two support elements of the individual carrier modules can each be pivoted runs in the longitudinal direction of the container. The fact that the two support elements of a carrier module can be folded together enables space-saving transport of the individual modules. In this case, the carrier modules are preferably designed in such a way that the support elements can be pivoted from a pivoted position lying on top of one another into a substantially stretched position, i.e. that the two support elements can be pivoted through approximately 180° relative to one another. In the folded position, the support elements can lie on top of each other so that the photovoltaic modules face each other or face away from each other.

In the unfolded pivot position, the two support elements of each carrier module may lie in a common plane or enclose an obtuse angle with each other. In the first case, a planar module is obtained, while in the second case, a gable or gable roof-like design is achieved.

Preferably, the individual carrier modules can be interconnected prior to mounting on a container roof to form the photovoltaic device of the invention. For this purpose, according to the invention, first connecting supports are provided which run parallel to the pivot axis and are attached to the support elements at the end regions of the support elements facing away from the pivot axis. In this case, the first connecting supports form a rigid connection between adjacent support elements. The plurality of carrier modules interconnected in this way can be lifted onto a container roof by conventional lifting devices, such as a forklift truck or a crane, wherein second connecting supports are mounted on the outermost carrier modules, which are designed for coupling to a corner fitting of the container, for which purpose the second connecting supports are designed to project in the longitudinal direction (i.e. in the direction of the at least one pivot axis) and can be connected to the corner fittings of the container.

In an equally simple manner, the photovoltaic device according to the invention can be removed from the container roof again by detaching the second connecting supports from the corner fittings and lifting the photovoltaic device from the container roof with a lifting device.

The invention enables the flexible use of photovoltaic modules on container roofs due to the simple assembly and disassembly and the transportability enabled by the foldability. In this case, the containers and the photovoltaic devices according to the invention can be brought to a place of use separately from each other and the containers can be provided with a photovoltaic device as required.

In order to make do with a standardized design of the carrier modules and still allow adaptation to different dimensions of containers, a preferred further development of the invention provides that the support elements have extendable and retractable arms perpendicular to the pivot axis, to which the first connecting supports are attached. The extendable and retractable arms can, for example, be designed as telescopable arms. In this way, a stepless adjustment to the container width can be made.

An advantageous design of the support elements provides that the support elements each comprise a frame for supporting the photovoltaic module, wherein the frame comprises two arms extending substantially perpendicular to the pivot axis and a cross member connecting the end regions of the arms facing away from the pivot axis.

To facilitate the assembly of the first connecting supports to the support elements, it can be provided that the support elements each carry two connecting pieces spaced apart in the direction of the pivot axis.

The connecting pieces are advantageously attached to the extendable and retractable arms.

In a preferred manner, the connecting pieces project over the edge of the photovoltaic module facing away from the pivot axis, so that the first connecting supports attached thereto form a lateral edge of the photovoltaic device according to the invention and at the same time form bearing elements for supporting the photovoltaic device on the container roof.

In this context, it is preferably provided that the first connecting supports and, if applicable, the second connecting supports have a flat bearing surface for bearing on the roof of the container.

In order to enable simple mounting of the photovoltaic device according to the invention on the container roof, the second connecting supports preferably each have a fastening piece at their free ends for positive connection to the corner fitting of the container. The container roof is preferably fastened only at the corner fittings, so that additional fastening points can be omitted.

The corner fittings of containers are usually standardized, so that the fastening pieces can be made uniformly. Corner fittings for ISO containers that are designed for a so-called twistlock connection are widely used. In the case of fasteners for a twistlock connection, the positive connection is locked by rotating part of the fastening piece. In this connection, a preferred further development of the invention provides that the fastening piece has a rotatable locking member which is designed to be inserted into an opening of the corner fitting and to positively engage behind the opening after a rotation.

The fastening pieces may further include an engagement member for a lifting device, such as a crane, so that the container can be lifted by the lifting device and moved to another location. The lifting device grips the container at all four fastening pieces as would otherwise be the case without the arrangement of the photovoltaic device by direct coupling to the corner fittings.

The container is preferably designed as a standard container, such as an ISO container, such as a 20′, 30′ or 40′ (′=feet) ISO container.

At least one inverter is provided to convert the direct current provided by the photovoltaic modules into alternating current. Depending on the technical design, a separate inverter can be used for each photovoltaic module or one inverter can also be provided for several photovoltaic modules. The inverter(s) can preferably be located on the underside of the photovoltaic module. The inverter(s) may preferably be attached to the cross members of the support elements. In case of a plurality of inverters, their outputs are combined and connected to one junction box. The junction box can be mounted on one of the fastening pieces. Any electrical consumers can be supplied with alternating current from the junction box. In particular, the container, i.e. the loads located within the container, can be supplied with alternating current. The junction box is equipped with preferably standardized plug connections (e.g. CEE couplings).

According to a second aspect, the invention provides a set for assembling a photovoltaic device according to the first aspect, comprising at least two foldable carrier modules each having two support elements pivotable relative to each other about a pivot axis, a photovoltaic module being attached to each support element, a plurality of first connecting supports for connecting the support elements of adjacent carrier modules, and second connecting supports configured for coupling to a corner fitting of the container.

The foldable carrier modules can be stacked on top of each other in folded condition and be accommodated in a transport box together with the other parts of the set, thus enabling space-saving transport.

According to a third aspect, the invention provides a container having a photovoltaic device mounted on the roof thereof according to the first aspect.

As already mentioned in connection with the first aspect of the invention, the attachment of the photovoltaic device to the container roof is preferably performed by attaching the second connecting supports of the photovoltaic device to corner fittings of the container.

The fastening piece of the second connecting supports can be positively connected to the respective corner fitting.

### BRIEF DESCRIPTION OF THE DRAWINGS

The invention is explained in more detail below with reference to an example of an embodiment shown schematically in the drawing. In the drawings:

FIG. 1 shows a photovoltaic device according to the invention on a container roof,

FIG. 2 shows the photovoltaic device of FIG. 1 without container,

FIG. 3 shows a carrier module of the photovoltaic device of FIG. 1,

FIG. 4 shows a carrier module with extended arms,

FIG. 5 shows a carrier module in folded state, and

FIG. 6 shows an exploded view of the photovoltaic device of FIG. 1 without photovoltaic modules.

### DETAILED DESCRIPTION

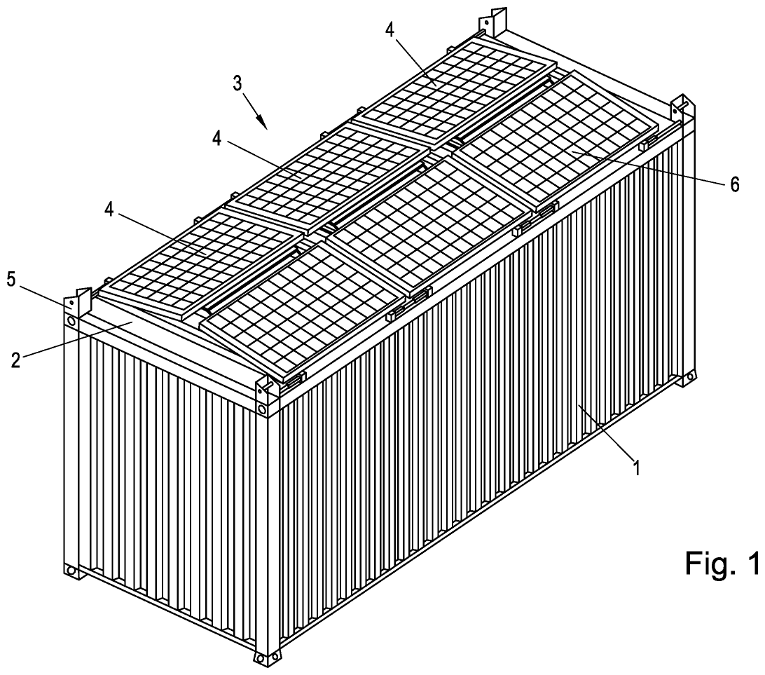

FIG. 1 shows an ISO container 1 carrying a photovoltaic device 3 on its roof 2. The photovoltaic device 3 is composed of three carrier modules 4 lined up longitudinally and attached to the corner fittings 5 of the container 1. Each carrier module 4 carries two photovoltaic modules 6.

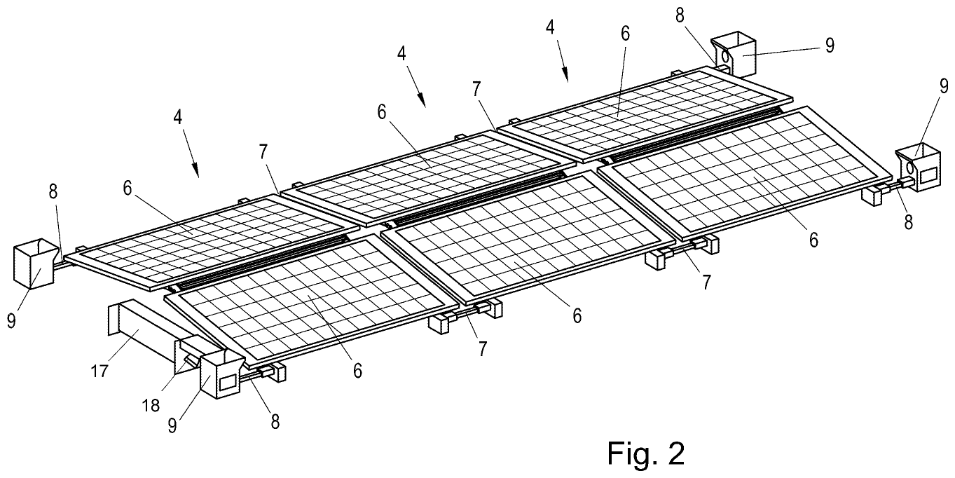

In FIG. 2, it can be seen that adjacent carrier modules 4 are each connected to one another with two first connecting supports 7, and that the carrier modules 4 located on the outside each have second connecting supports 8 projecting outwards in the longitudinal direction, which support fastening pieces 9 at their free ends, with which the photovoltaic device 1 can be positively connected to the corner fittings 5. The fastening pieces 9 can be designed as twistlock fasteners. Furthermore, FIG. 2 shows an electrical junction box 17 in which the outputs of the inverters (not shown) assigned to the individual photovoltaic modules 6 or a group of photovoltaic modules 6 are combined. The junction box 17 may be mounted on any of the four fastening pieces 9. AC power can then be supplied to container 1 from junction box 17. The junction box 17 is equipped with standardized plug connections 18 (e.g. CEE couplings).

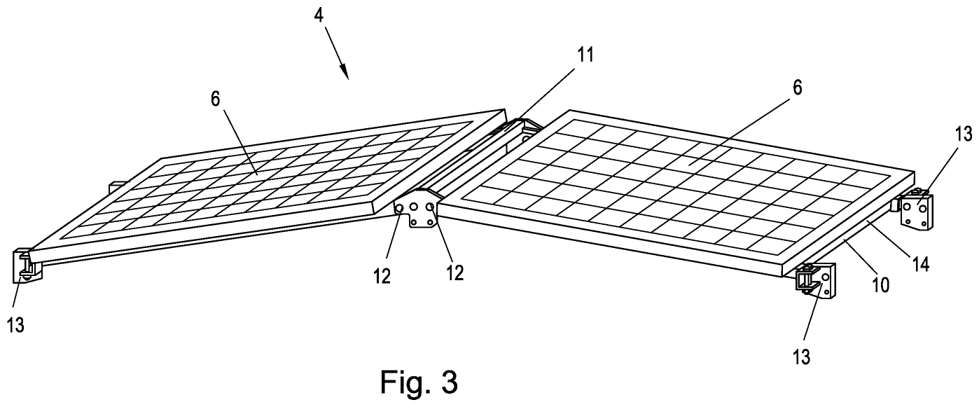

In FIG. 3, a carrier module 4 is shown separately and it can be seen that the carrier module 4 comprises two support elements 10 that can be pivoted relative to each other, each of which carries a photovoltaic module 6. Here, the support elements 10 are each mounted on a center piece 11 so that they can swivel about a pivot axis 12. Connecting pieces 13 are attached to a cross member 14 of the support element 10 at the two end regions, to which the first connecting supports 7 and the second connecting supports 8 are mounted, respectively.

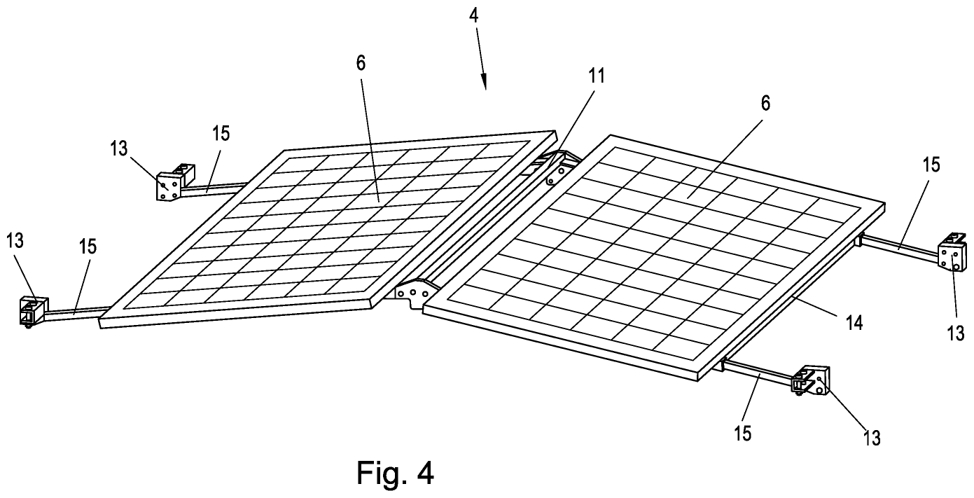

In the design according to FIG. 4, the connecting pieces 13 are arranged on telescopic arms 15 to allow adaptation to different container widths.

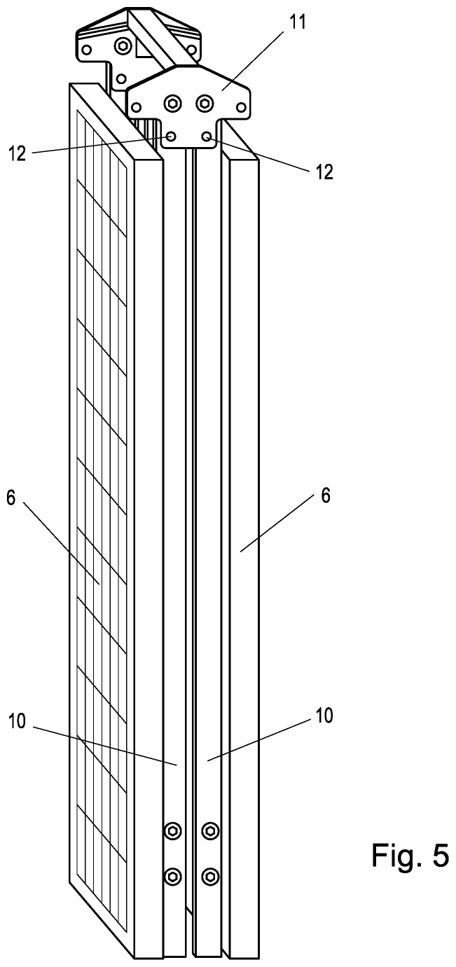

In FIG. 5, the carrier module 4 is shown in a folded state, with the two support elements 10 lying against each other and the photovoltaic modules 6 coming to rest on sides of the folded carrier module 4 facing away from each other.

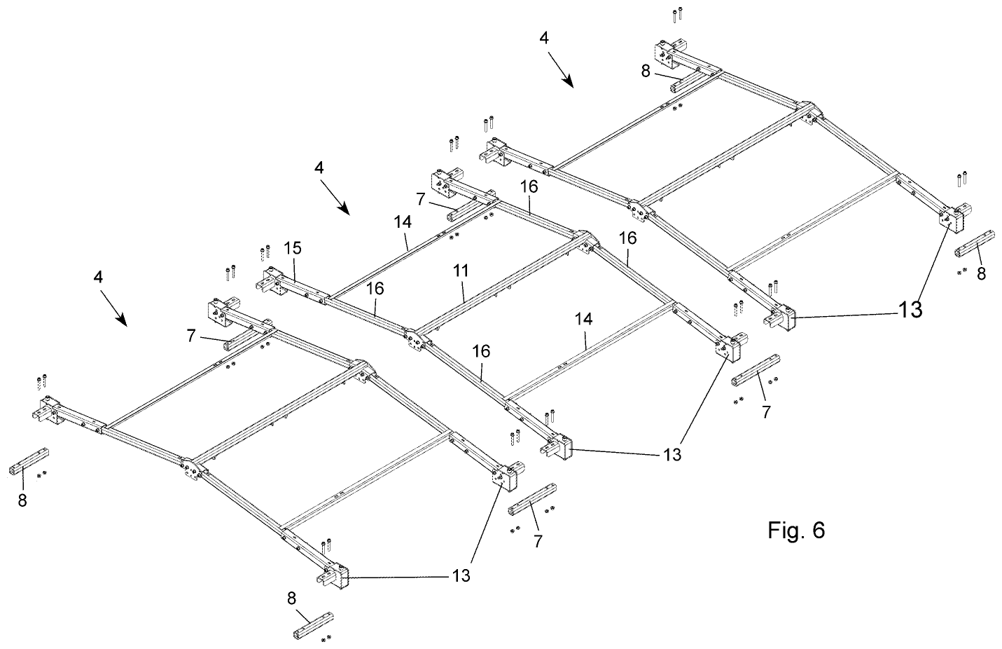

In the exploded view according to FIG. 6, the structural design of the support elements 10 is better apparent. Each of the three support elements 10 includes a frame for supporting the photovoltaic module 6, the frame having two arms 16 extending substantially perpendicular to the pivot axes 12 and a cross member 14 connecting the end portions of the arms 16 remote from the pivot axis 12.

1-14. (canceled)

15. A photovoltaic device for mounting on a container, comprising:
at least two foldable carrier modules, each of the at least two foldable carrier modules having two support elements pivotable relative to one another about at least one pivot axis;
a photovoltaic module fastened to each support element;
wherein the at least two foldable carrier modules are arranged adjacent to one another, the at least one pivot axes are aligned with one another, and the support elements of adjacent carrier modules are connected to one another by first connecting supports;
wherein the first connecting supports extend parallel to the at least one pivot axis and are fastened to the support elements at end regions thereof remote from the pivot axis; and
wherein second connecting supports are fastened to the support elements of an outermost one of the at least foldable two carrier modules, the second connecting supports being configured to couple to a corner fitting of the container.

16. The photovoltaic device according to claim 15, wherein the support elements have arms configured to be extended and retracted perpendicularly to the pivot axis and to which the first connecting supports are attached.

17. The photovoltaic device according to claim 15, wherein the support elements each have a frame for supporting the photovoltaic module, the frame having two arms running substantially perpendicular to the pivot axis and a cross member connecting further end regions of the arms facing away from the pivot axis.

18. The photovoltaic device according to claim 16, wherein the support elements each carry two connecting pieces spaced apart from one another in a direction of the pivot axis.

19. The photovoltaic device according to claim 18, wherein the connecting pieces are attached to the extendable and retractable arms.

20. The photovoltaic device according to claim 18, wherein the connecting pieces project beyond an edge of the photovoltaic module facing away from the pivot axis.

21. The photovoltaic device according to claim 15, wherein the first connecting supports have a flat bearing surface for bearing on a roof of the container.

22. The photovoltaic device according to claim 21, wherein the second connecting supports have a further flat bearing surface for bearing on the roof of the container.

23. The photovoltaic device according to claim 15, wherein the second connecting supports have at a free end a fastening piece for positive connection to the corner fitting of the container.

24. The photovoltaic device of claim 23, wherein the fastening piece comprises a rotatable locking member configured to be inserted into an opening of the corner fitting and to positively engage behind the opening after rotation.

25. A set for assembling a photovoltaic device according to claim 15, comprising:
at least two foldable carrier modules, each of the at least two foldable carrier modules having two support elements pivotable relative to one another about at least one pivot axis;
a photovoltaic module fastened to each support element; and
a plurality of first connecting supports for connecting the support elements of adjacent carrier modules; and
a plurality of second connecting supports which configured to couple to a corner fitting of the container.

26. A container having a photovoltaic device mounted on a roof, comprising:
the container; and
the photovoltaic device, the photovoltaic device comprising:
at least two foldable carrier modules, each of the at least two foldable carrier modules having two support elements pivotable relative to one another about at least one pivot axis;
a photovoltaic module being fastened to each support element;
wherein the at least two foldable carrier modules are arranged adjacent to one another, the at least one pivot axes are aligned with one another, and the support elements of adjacent carrier modules are connected to one another by first connecting supports;
wherein the first connecting supports extend parallel to the at least one pivot axis and are fastened to the support elements at end regions thereof remote from the pivot axis; and
wherein second connecting supports are fastened to the support elements of an outermost one of the at least foldable two carrier modules, the second connecting supports being configured to couple to a corner fitting of the container.

27. The container according to claim 26, wherein the second connecting supports of the photovoltaic device are attached to corner fittings of the container.

28. The container according to claim 26, wherein the second connecting supports have at a free end a fastening piece that is positively connected to the respective corner fitting.

29. The container according to claim 26, wherein the first connecting supports rest on the roof of the container.
